(19) United States
(12) Patent Application Publication
(10) Pub. No.: US 2015/0203239 A1
(43) Pub. Date: Jul. 23, 2015

(54) COLLAPSIBLE CONTAINER AND BLANK THEREFOR

(71) Applicant: Natasha IWEGBU, Washington, DC (US)

(72) Inventor: Natasha IWEGBU, Washington, DC (US)

(21) Appl. No.: 14/158,212

(22) Filed: Jan. 17, 2014

(51) Int. Cl. B65D 5/02; B31B 5/00; B65D 5/36

(52) U.S. Cl. CPC B65D 5/029; B65D 5/3614; B31B 5/00

(57) ABSTRACT

A collapsible container and a blank therefor are disclosed. The collapsible container can include a top section, a bottom section hingedly coupled to the top section along a first side edge of the bottom section, a flap section disposed over the top section and hingedly coupled to the bottom section along a second side edge of the bottom section, a pair of first endwalls, each first endwall hingedly coupled to an end edge of the top section, and a pair of second endwalls, each second endwall hingedly coupled to an end edge of the bottom section.

### BACKGROUND

The use of containers to transport and store items is well known. For example, an individual may desire to use a container to carry many small items that can be easily scattered or to store and transport food items, such as a workplace lunch. A disadvantage of typical containers is that the container occupies the same volume regardless of whether it is empty or whether it has contents therein. A collapsible container that can easily be transformed between a flat configuration and a deployed configuration is therefore desired.

### SUMMARY

According to at least one exemplary embodiment, a collapsible container is disclosed. The collapsible container can include a top section, a bottom section hingedly coupled to the top section along a first side edge of the bottom section. There may be a flap section disposed over the top section and hingedly coupled to the bottom section along a second side edge of the bottom section. The collapsible container may also include a pair of first endwalls, each first endwall hingedly coupled to an end edge of the top section, and a pair of second endwalls, each second endwall hingedly coupled to an end edge of the bottom section. The top section is further divided by crease lines into narrower subsections. The bottom section is further divided by crease lines into at least three narrower subsections.

According to another exemplary embodiment, a blank for a collapsible container is disclosed. The blank can include a sheet of material divided by a pair of hinge lines into a top-forming section, a bottom-forming section and a flap-forming section. The top-. forming section may be hingedly coupled to the bottom-forming section and the bottom-forming section may be hingedly coupled to the flap-forming section. A pair of first endwall-forming sections may be hingedly coupled to the top-forming section, and a pair of second endwall-forming sections may be hingedly coupled to the bottom-forming section, and an opening may be defined in the top-forming section.

According to another exemplary embodiment, a method for forming a collapsible container is disclosed. The method can include providing a sheet of material divided by a pair of hinge lines into a bottom-forming section, a top-forming section hingedly coupled to the bottom-forming section and a flap-forming section hingedly coupled to the bottom-forming section, a pair of first endwall-forming sections hingedly coupled to the top-forming section, and a pair of second endwall-forming sections hingedly coupled to the bottom-forming section. The top and bottom sections may further be subdivided by crease lines into at least three narrower subsections, thereby creating a flat central portion and two diagonal portions. The method can further include folding the sheet so as to place the top-forming section facing and adjacent the bottom-forming section, folding the sheet so as to place the flap-forming section facing and adjacent the top-forming section, and aligning the endwall-forming sections.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1a shows an exemplary embodiment of a blank for a collapsible container.

FIG. 1b shows a second exemplary embodiment of a blank for a collapsible container.

FIG. 1c shows an exemplary embodiment of a blank for a collapsible container.

FIG. 1d shows an exemplary embodiment of a blank for a container.

FIG. 1e shows an exemplary embodiment of a blank for a container.

FIG. 1f shows an exemplary embodiment of a blank for a container.

FIG. 2a is a top view of an exemplary embodiment of a collapsible container in a collapsed configuration.

FIG. 2b is a cross-section view along line A-A of FIG. 2a.

FIG. 2c is a cross-section view along line B-B of FIG. 2a.

FIG. 2d is a cross-section view of another exemplary embodiment along line B-B of FIG. 2a.

FIG. 3a is a top view of an exemplary embodiment of a collapsible container in a deployed configuration.

FIG. 3b is a front view of an exemplary embodiment of a collapsible container in a three dimensional configuration.

FIG. 3c is a side view of an exemplary embodiment of a collapsible container in a three dimensional configuration.

FIG. 3d is a cross-section view along line C-C of FIG. 3a.

FIG. 3e is a cross-section view along line D-D of FIG. 3a.

FIG. 3f is a cross-section view of another exemplary embodiment along line D-D of FIG. 3a.

FIG. 4a shows a third exemplary embodiment of a blank for a collapsible container.

FIG. 4b shows a front view of third exemplary embodiment of a collapsible container in a three dimensional configuration.

FIG. 5a shows a fourth exemplary embodiment of a blank for a collapsible container.

FIG. 5b shows a front view of a fourth exemplary embodiment of a collapsible container in a three dimensional configuration.

FIG. 6a shows an additional exemplary embodiment of a blank for a collapsible container.

FIG. 6b shows an additional exemplary embodiment of a blank for a collapsible container.

FIG. 6c shows an additional exemplary embodiment of a blank for a collapsible container.

FIG. 6d shows an additional exemplary embodiment of a blank for a collapsible container.

FIG. 7a shows an additional exemplary embodiment of a blank for a collapsible container.

FIG. 7b shows a cross-section of an additional exemplary embodiment of a blank for a collapsible container in a three dimensional configuration.

FIG. 7c shows a cross-section of an additional exemplary embodiment of a blank for a collapsible container in a three dimensional configuration.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

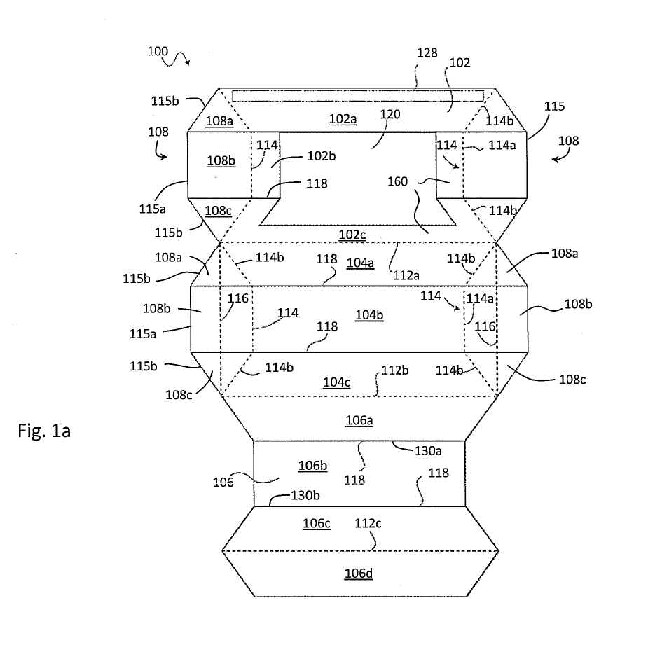

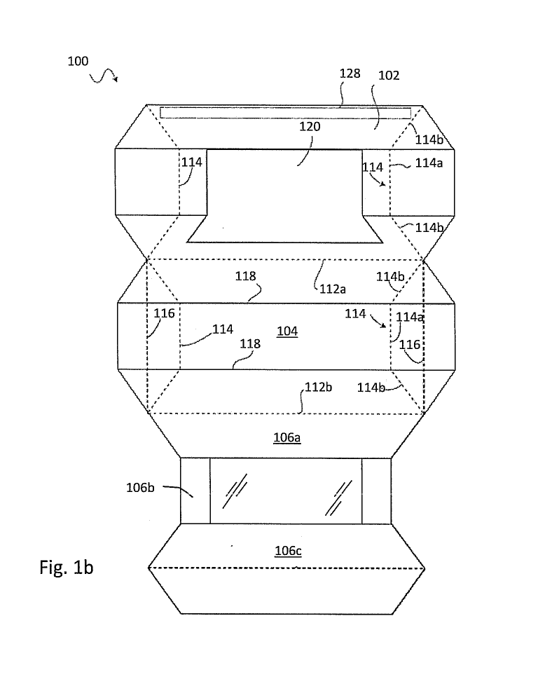

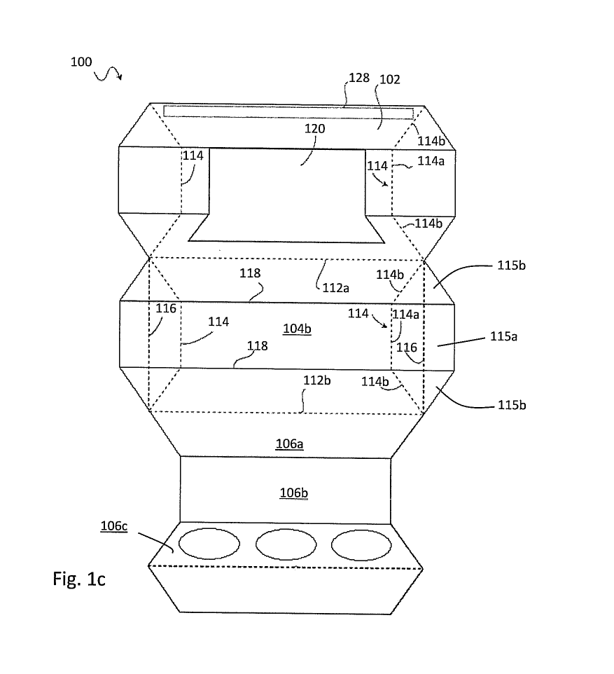

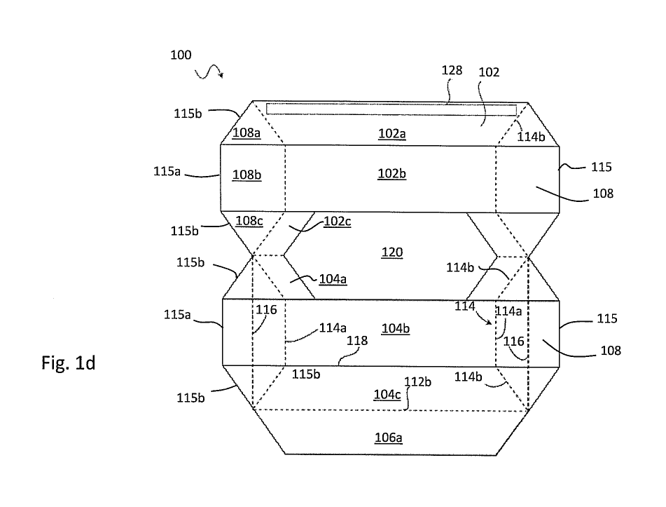

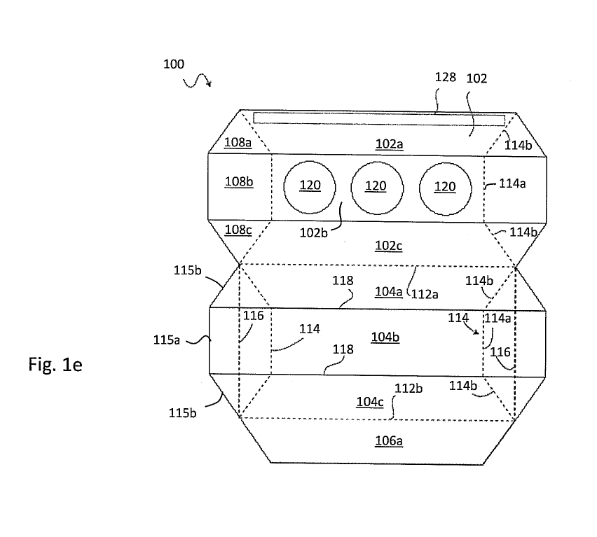

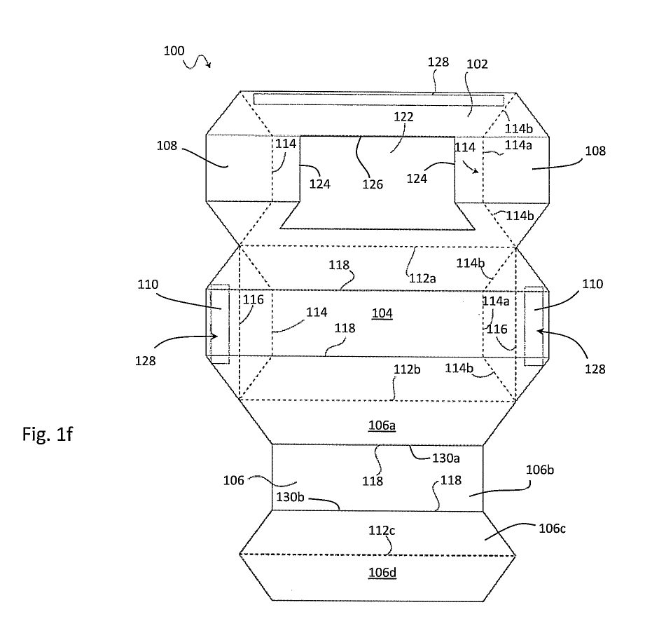

Referring to the figures generally, a collapsible container may be shown. FIGS. 1a-1f show exemplary embodiments of a blank 100 for a collapsible container. The blank may generally be divided into three sections, a top section 102 hingedly coupled to a bottom section 104, and a flap section 106 hingedly coupled to an opposing edge of bottom section 104. The shapes of top section 102 and bottom section 104 may be substantially similar. Longitudinal hinge line 112a may separate top section 102 from bottom section 104, while longitudinal hinge line 112b may separate flap section 106 from bottom section 104. Top section 102 may be further divided by longitudinal crease lines 118 into subsections 102a, 102b and 102c. The bottom section may be further divided by longitudinal crease lines 118 into subsections 104a, 104b and 104c. The flap section may be further divided by longitudinal crease lines 118 into subsections 106a, 106b, 106c and 106d. The subsections on the top, bottom and flap sections create central portions 102b, 104b, 106b and diagonal portions 102a, 102c, 104a, 104c, 106a 106c and 106d.

Each of the top and bottom sections may further be hingedly coupled to endwall sections 108, disposed at both longitudinal ends of each of the top and bottom sections. The endwall sections 108 can be disposed between hinge lines 114 and the proximate transverse edges 115 of top and bottom sections 102, 104. Each hinge line 114 may include a segment 114a extending substantially transversely between a pair of crease lines 118. Each hinge line 114 can further include a pair of segments 114b extending substantially diagonally between the transverse segment and a terminal end proximate the edge of the corresponding top section 102 or bottom section 104. Each transverse edge 115 may further include a segment 115a extending substantially transversely between a pair of crease lines 118 and a pair of segments 115b extending diagonally between the crease lines 118 and the terminal end proximate edge of the top section 102 and bottom section 104. Each endwall 108, may be divided by crease lines 118 into 108a, 108b, and 108c.

Flap section 106 may have a shape substantially similar to the portion of top section 102 that is disposed between hinge lines 114. The flap section is divided into subsections 106a, 106b and 106c, by hingelines 130a and 130b. In some exemplary embodiments, flap section 106 may have a shape substantially similar to the portion of top section 102 that is disposed between hinge lines 114 plus a portion 104a of bottom section 104 that is adjacent top section 102c and disposed between hinge lines 114 and a crease line 118. In such embodiments, flap section 106 may be partitioned by a hinge line 112c. The extra portion 106d may be couplable to section 104a when the flap portion 106 is closed over top portion 102. In some exemplary embodiments the flap section consists of only section 106a, thereby creating a flap to couple to section 102a on top section 102 as shown in FIGS. 1d and 1e. In some exemplary embodiments the flap may contain cutout windows in sections 106b and 106c that maybe sealed with a clear sheet material thereby creating a see through window into the container as shown in FIG. 1b. In some exemplary embodiments the flap may contain cutout windows in section 106c, thereby enabling side viewing or access into the container through the diagonal face as shown in FIG. 1c.

In some exemplary embodiments, top section 102 may include an aperture 120 defined therein, as shown in FIG. 1a. A rim 160 may be formed between the perimeter of aperture 120 and hinge line 112a and between the perimeter of aperture 120 and crease lines 114. In some exemplary embodiments rim 160 may include notches or scalloped sections. In other exemplary embodiments rim 160 may include a thumb rest surface. In some exemplary embodiments there may be multiple apertures 120 in the top section as shown in FIG. 1e. In other exemplary embodiments, an aperture 120 may be formed in the top and bottom section as shown in FIG. 1d. In other exemplary embodiments, as shown in FIG. 1f, aperture 120 may be a partial cutout creating a secondary lid 122, which may be separated from blank 100 by cut lines 124 while being hingedly coupled to blank 100 by a hinge line 126. In further exemplary embodiments, secondary lid 122 may be detachable from blank 100, with lines 124 and 126 being provided as perforations to facilitate detaching lid 122.

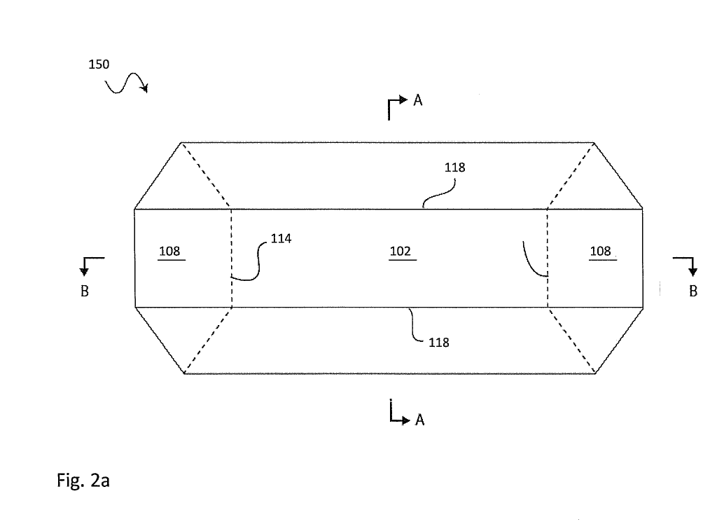

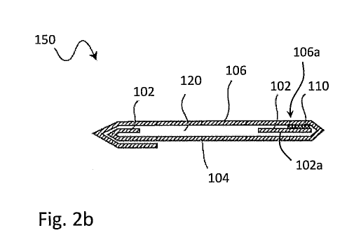

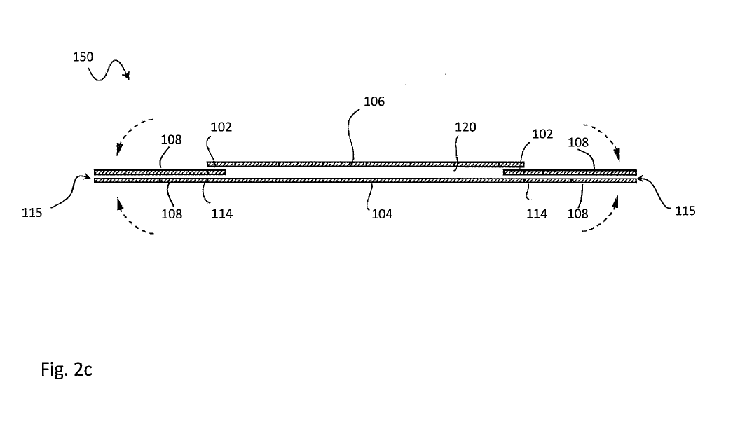

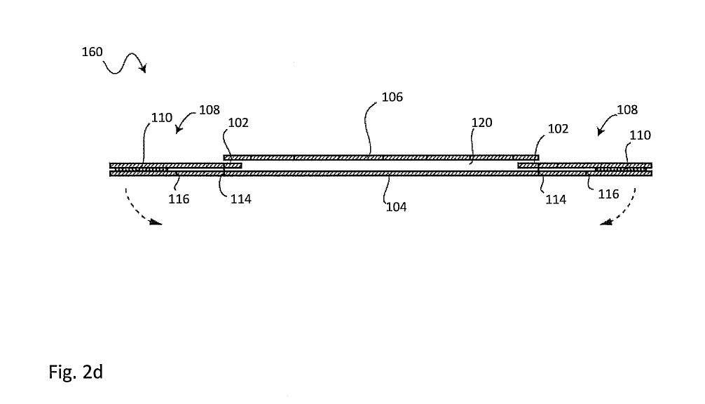

Focusing on FIGS. 2a-2c, to form a collapsible container 150 from blank 100, the blank may first be folded along hinge line 112a such that top section 102 is disposed adjacent and facing bottom section 104.

Subsequently, blank 100 may be folded along hinge line 112b such that flap section 106 is disposed adjacent and facing top section 102, and such that top section 102 is disposed between flap section 106 and bottom section 104. Top section 102a and flap section 106a may then be adhered or fastened to each other proximate hingeline 112b. This may be accomplished by the provision of an adhesive 110 substantially at adhesive areas 128 (shown in FIGS. 1a-1e) on blank 100, the adhesive areas being oriented on a face of blank 100 so as to allow the collapsible container to be formed as described herein. Alternatively, sections 102 and 106 may be coupled by fasteners such as tacks, staples, thermal heat sealing or any other known methods, disposed substantially at areas 128 (shown in FIGS. 1a-1e). Furthermore, flap section 106 may be folded along hinge line 112c, allowing a portion of flap section 106 to overlap a portion of bottom section 104.

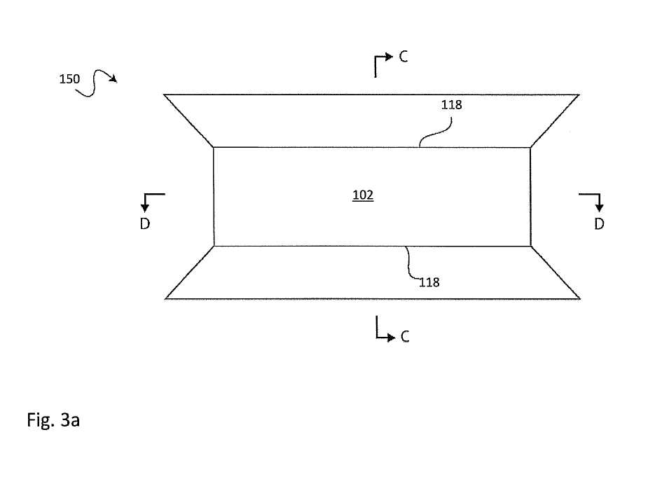

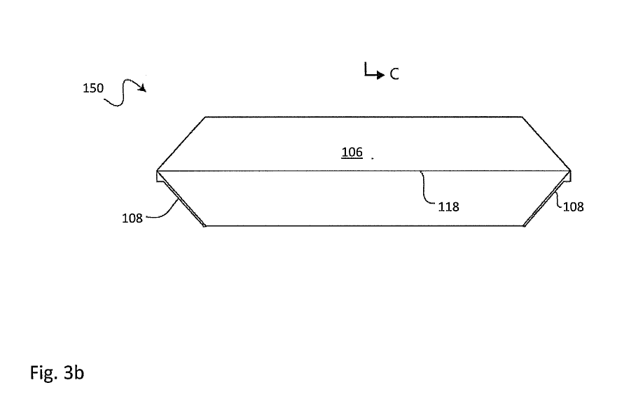

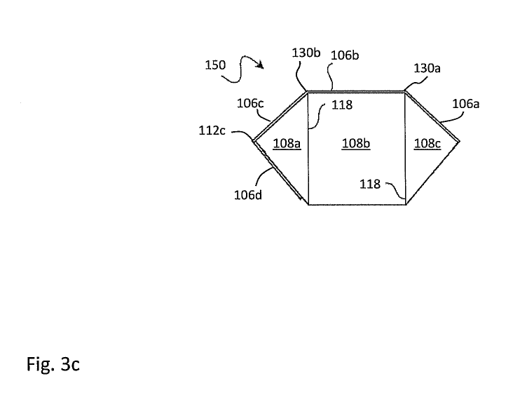

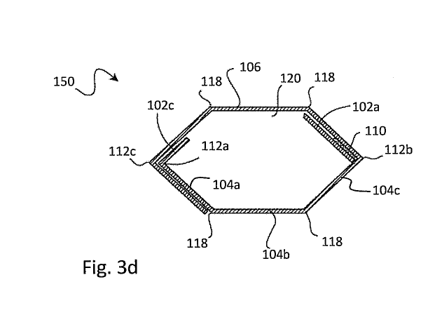

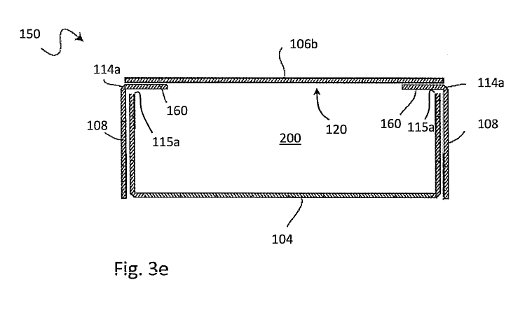

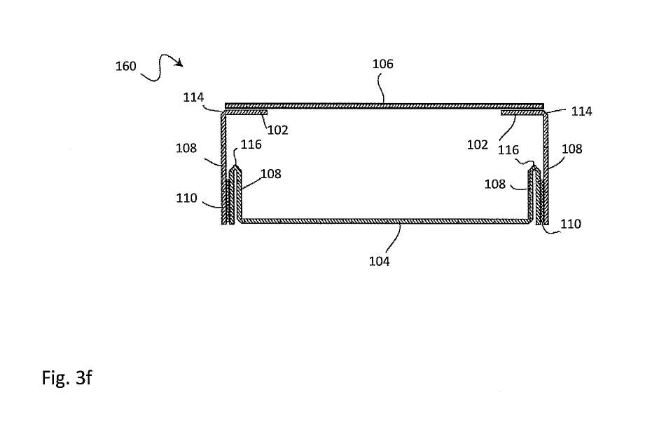

FIGS. 2a-2c show a collapsible container 150 formed from blank 100 in its substantially flat, collapsed configuration, while FIGS. 3a-3e show a container 150 in a deployed configuration. To place container 150 in a deployed configuration, the pair of second endwall-forming sections 108, coupled to the bottom-forming section 104, may pivot upwards along hinge line 114 and the pair of first endwall-forming sections 108 coupled to the top-forming section, 102, may pivot downwards along hinge line 114. Vertex points on the endwalls 108 may correspond to the crease lines 118 on the top and bottom sections, these may act as live hinges rotating to accommodate the height of the endwalls 108, as shown in FIGS. 3c and 3d. The geometry of the endwall defines the cross section of the container. Flat segments 115a on the second endwalls interface with crease line 114a on the top section, creating a load bearing lock, forming the flat surface of the container. Diagonal segments 115b interface with 114b further strengthening the lock and forming the diagonal surfaces of the container. In some exemplary embodiments the diagonal segments may be divided in further sub-segments.

In some exemplary embodiments, Top section 102 and bottom section 104 may then be adhered or fastened to each other at the endwalls 108 between the creaselines 116 and the terminal end of the blank. This may be accomplished by the provision of an adhesive 110 substantially at adhesive areas 128 (shown in FIG. 1f) on blank 100, the adhesive areas being oriented on a face of blank 100 so as to allow the collapsible container to be formed. FIG. 2d shows a collapsible container 160 formed from blank 100 in FIG. 1f, in its substantially flat, collapsed configuration, while FIG. 3f shows a container 160 in a deployed configuration.

To place container 160 into a deployed configuration, the endwall sections 108 may be depressed inwardly and in the direction of bottom section 104, as shown by the dotted arrows in FIG. 2d. Depressing the endwall sections 108 as shown can cause the endwall sections 108 that coupled to top section 102 to pivot downwardly along hinge line 114. This can also cause the endwall sections 108 that coupled to bottom section 104 to pivot upwardly along hinge line 114 and downwardly along hinge line 116, so as to form the configuration shown in FIG. 3f. The endwalls of container 160 can then assume a substantially concave shape, with hinge line 114 defining the shape of the sides of container 160, as shown in FIG. 3a. The pivoting action of the endwall sections can further cause top, bottom, and flap sections 102, 104, 106 to bend along crease lines 118, thereby allowing container 160 to assume a deployed configuration, as shown in FIGS. 3a-3d. To collapse container 160, the endwalls 108 may simply be pivoted in the reverse direction.

Hinge lines 130a and 130b in the flap section, allow the flap 106, to fold into section 106a, 106b and 106c and follow the contour of the top section, forming a lid. Section 106b lies flat adjacent to top section 102b, as defined by the endwall 108b. In some exemplary embodiments the flap section may include an overlapping subsection 106d, defined by hinge line 112c. When in use, subsection 106d folds over hinge line 112a and overlaps a portion of section 104a on the bottom forming section, thereby further sealing the container. Rotating the flap open via hinge 130b enables partial opening of the container, in the rotated open position, the underside of section 106c is presented at an angle and provides a signage surface. Rotating the flap open via hinge 130a enables full opening of the container, in the rotated open position, the underside of section 106b is presented at an angle and provides a signage surface. In other exemplary embodiments there maybe a further crease line, longitudinally across the center of section 106b. This would allow the lid to fold thereby not obstructing the view of the user, when the container is in use. In further exemplary embodiments the flap portion consists of 106a alone. This is to provide coupling surface to the top forming portion 102 as shown in FIG. 1d. Due to crease lines 118 and hinge lines 130a, 130b, 112c, the container can be made from both rigid and flexible sheet material. Flap sections may have a window cutout as shown in blank 100 of FIG. 1b or multiple cutouts as shown in FIG. 1c.

FIGS. 1a and 3e show rim 160 may be created between the aperture 120 and hinge line 112a and crease lines 114a on both longitudinal edges, thereby forming a rim around the aperture 120. The rim 160 secures end wall segments 115 in place and forms part of the said load bearing lock. Further rim 160 secures items within the cavity 200 and creates a gripping surface to hold the container. In some exemplary embodiments the rim 160 may include a thumb rest surface. In other exemplary embodiments rim 160 may include notches or scalloped sections, to secure the placement of tools or utensils within the container. The flap sections 106b and 106c interface with the rim 160, thereby sealing the aperture, 120, of the cavity.

The bottom forming section is deployed into two diagonal sections 104a and 104c and a flat portion 104b. The top forming section is deployed into two diagonal sections 102a and 102c and a flat section 102b. Flat sections 104b and 102b allow the container to be set flat on a surface or stacked, one atop the other. FIG. 1d shows an aperture in the diagonal portions 102c and 104a, these allow access into the cavity of the container from the sides, enabling side loading and viewing, even when stacked. Further in some exemplary embodiments, the surfaces of the container or blank may be utilized for branding or signage, particularly flat surfaces 106a, 106b, 106c and 108b.

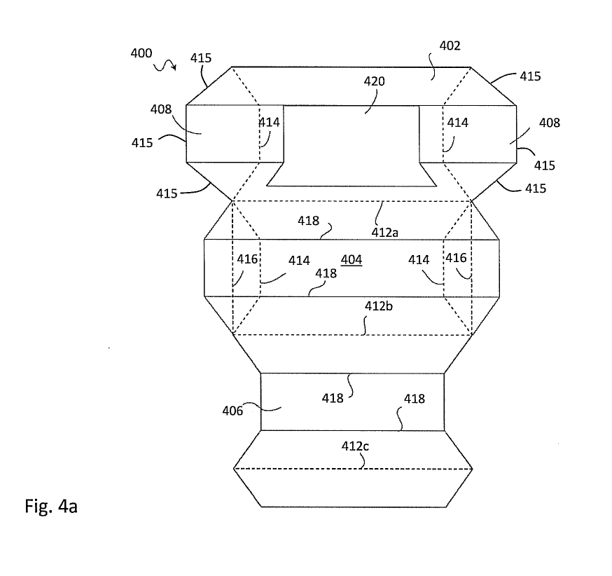

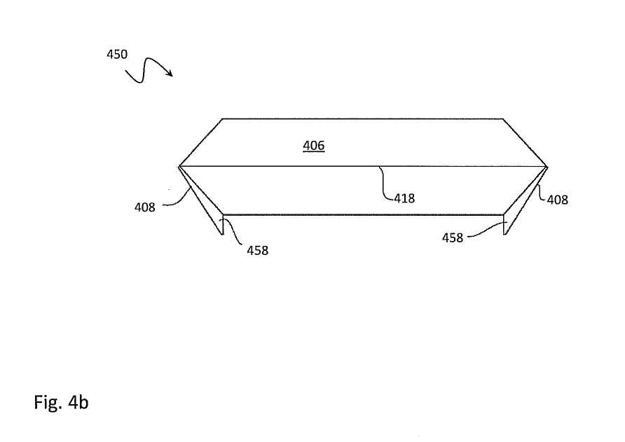

In some exemplary embodiments, variations in the configuration of the container blank may be provided so as to include additional features in the collapsible container. FIG. 4a shows another exemplary embodiment of a blank 400 for a collapsible container. Features similar to the embodiment of blank 100 are indicated by similar reference numerals, but with a hundreds digit of 4. In an exemplary embodiment of blank 400, the height of the first endwall sections 408, measured as the spacing between the hinge lines 414 and the transverse edges 415, may be increased. Consequently, when container 450 is formed from blank 400, as shown in FIG. 4b, the first endwalls 408 may have a height greater than the height of container 450 measured as the distance from the top section to the bottom section. Endwalls 408 can therefore act as stands or supports 458 for container 450.

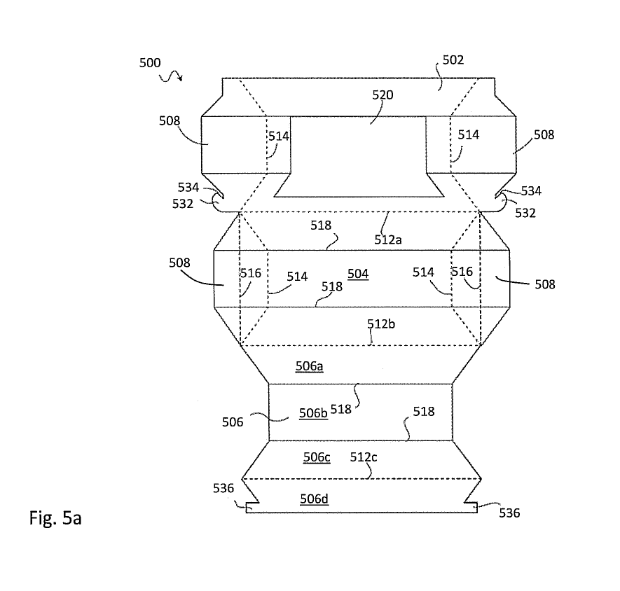

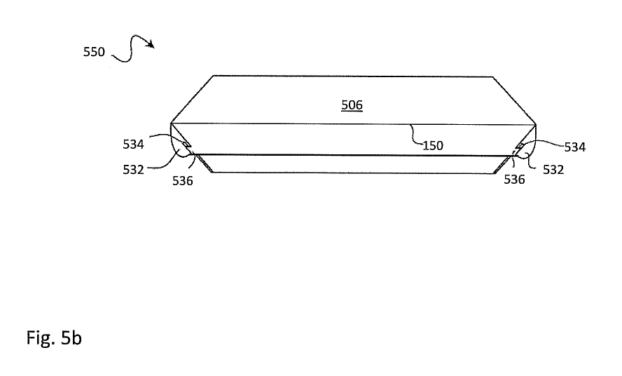

FIG. 5a shows another exemplary embodiment of a blank 500 for a collapsible container. Features similar to the embodiment of blank 100 are indicated by similar reference numerals, but with a hundreds digit of 5. In the exemplary embodiment of blank 500, tabs 532 may be provided at the edges of each endwall 508, and proximate hinge line 512a. Each tab 532 may be coupled to the corresponding endwall 508, and may be shaped so as to define a slit 534 between the tab 532 and the edge of the endwall 508. Additionally, latching tabs 536 may be provided proximate the longitudinal edge of flap section 506d and extending longitudinally past the proximate transverse edge of the flap section 506d. Consequently, when container 550 is formed from blank 500, as shown in FIG. 5b, the latching tabs 536 can be received within slit 534, thereby facilitating maintaining flap section 506 in a closed configuration. The user may withdraw the tabs 536 from slits 534 when it is desired to open container 550.

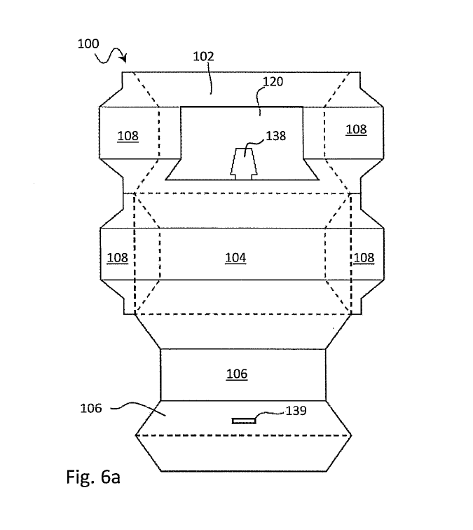

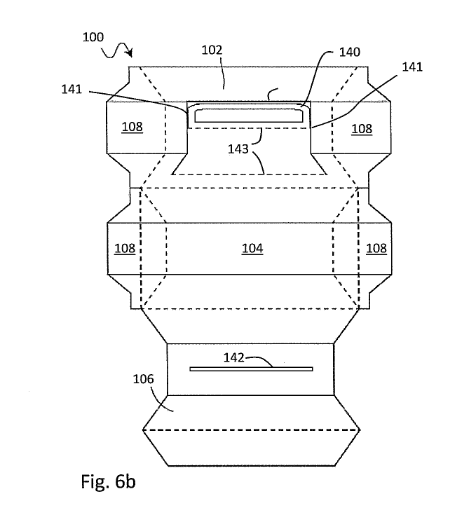

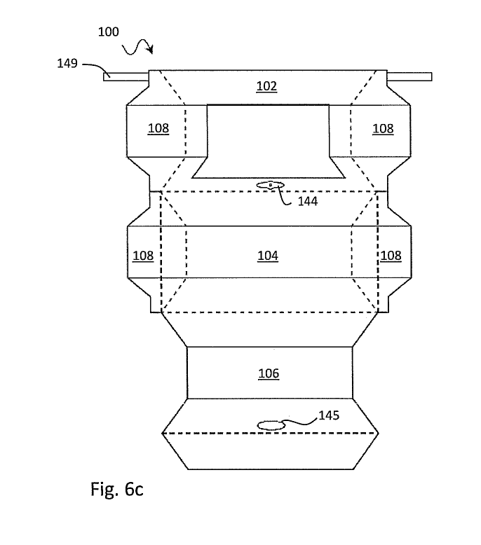

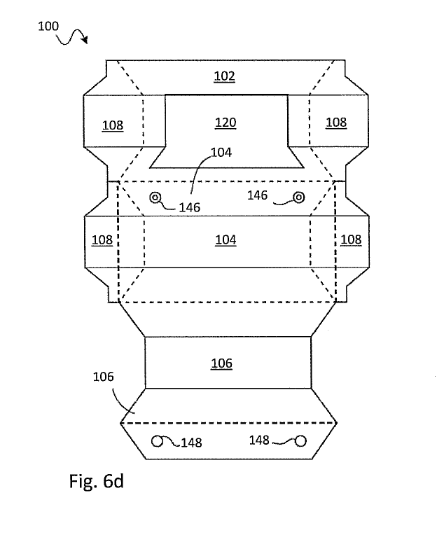

Turning to FIGS. 6a-6c, in some exemplary embodiments, various closure structures for maintaining the flap section in a closed configuration may be provided. In some exemplary embodiments, as shown in FIG. 6a, blank 100 can include a tab 138 hingedly coupled thereto and extending into aperture 120. When container 150 is in a deployed configuration, tab 138 may be pivoted so as to be received in a slot 139 defined in flap section 106. In further exemplary embodiments, as shown in FIG. 6b, blank 100 can include a handle 140 hingedly coupled thereto and extending into aperture 120. Slits 141 may be defined between the handle 140 and the edge of aperture 120. When container 150 is in a deployed configuration, handle 140 may be pivoted, via hingelines 143, so as to be received within slot 142, defined in flap section 106. Handle 140 can then engage the edges of slot 142, maintaining flap section 106 in a closed configuration and further allowing the user to carry the container via the handle 140.

In yet further exemplary embodiments, a latch 144 may be pivotably coupled to bottom section 102. When container 150 is in a deployed configuration, latch 144 may be received in a slot 145 defined in flap section 106. Latch 144 may then be pivoted in an orientation that precludes latch 144 from being withdrawn from slot 145, thereby maintaining flap section 106 in a closed configuration. In yet further exemplary embodiments, fasteners 146 may be provided on bottom section 104, and complementary fasteners 148 may be provided on flap section 106. When container 150 is in a deployed configuration, fasteners 146 may engage complementary fasteners 148 so as to maintain flap 106 in a closed configuration. The fastener and complementary fastener pairs may be any known fasteners, such as snaps, hook-and-loop fasteners, and so forth. In some exemplary embodiments, bendable extensions may be disposed from the container to secure the orientation of the container. For example, bendable wire 149 may be disposed from section 102 so that it may bend over section 106, locking the orientation of the container.

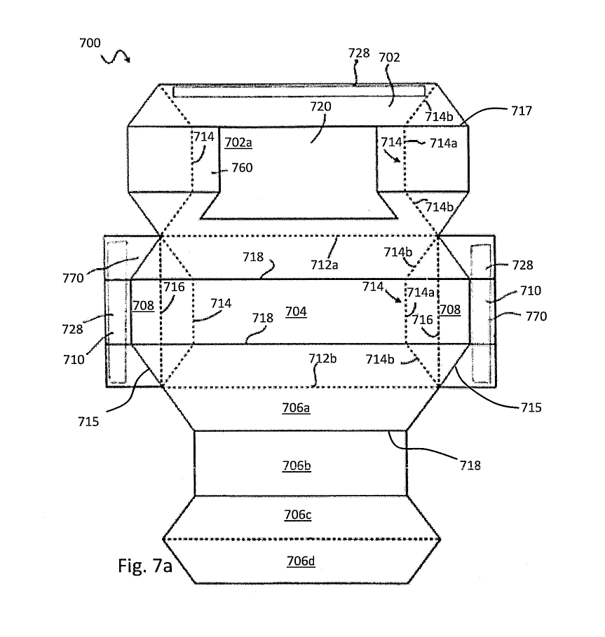

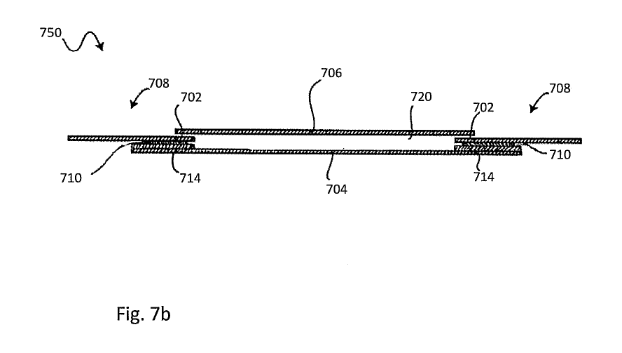

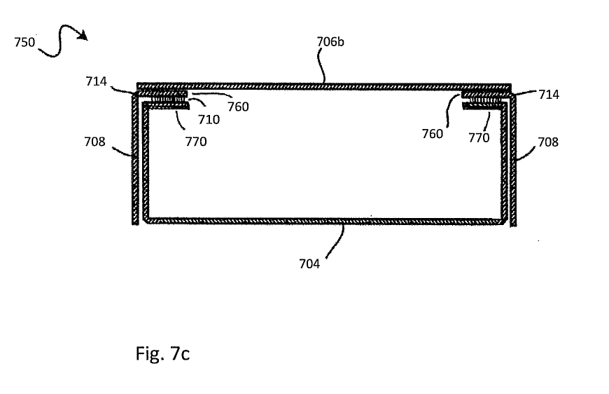

Focusing on FIGS. 7a-7c. FIG. 7a shows another exemplary embodiment of a blank 700 for a collapsible container. Features similar to the embodiment of blank 100 are indicated by similar reference numerals, but with a hundreds digit of 7. In the exemplary embodiment of blank 700 the second pair of end walls hingedly coupled to an edge of the bottom section are extended to create an additional sealing portion 770. To form a collapsible container 750 from blank 700, the blank may first be folded along hinge line 716, such that half of the endwall 708 is disposed over the other half and the extended sealing portion 770 is disposed over and adjacent to the bottom portion 704, between the hingeline 714 and the proximate rim edge 760. The blank may then be folded along hinge line 712a such that top section 702 is disposed adjacent and facing bottom section 704. Extended sealing portion 770 and top portion 702 may then be adhered or fastened to each other. This may be accomplished by the provision of adhesive 710 at adhesive areas 728. Subsequently, blank 700 may be folded along hinge line 712b such that flap section 706 is disposed adjacent and facing top section 702, and such that top section 702 is disposed between flap section 706 and bottom section 704. Top section 702a and flap section 706a may then be adhered or fastened to each other proximate hingeline 712b. This may be accomplished by the provision of an adhesive 710 substantially at adhesive areas 728 (shown in FIG. 7a) or by creating latches within the blank which will attach edge 717 to 718. FIG. 7b shows a collapsible container 750 formed from blank 700, in its substantially flat, collapsed configuration, while FIG. 7c shows the container 750 in a deployed configuration.

Still focusing on FIG. 7a, in other exemplary embodiments, section 702a and 702b of the top section may be eliminated, leaving only section 702c to be coupled to the extended sealing portion. This may be accomplished by adhesive, fasteners or by creating a latch within the blank. In further exemplary embodiments, Sections 702c and 706a may be coupled to the extended sealing portion 770, while Section 702a, 702b, 706b and 706c may form handles to facilitate closing and carrying the container.

It should be appreciated that the above-described closure structures can be utilized with any embodiments of the collapsible container blanks disclosed herein. Variations on the above-described closure structures, as well as other closure structures may be contemplated and provided as desired without departing from the spirit of the invention.

It should be appreciated that blank 100 may be made from any suitable materials. For example, the incremental eating tool 100 may be made from any suitable polymer or polymer blend, from paper-based products such as card stock, folding boxboard, paperboard, cardboard, foil, and the like, as well as from silicone or any other desired material. Furthermore, the surfaces of paper-based portions of blank 100 may include a coating, for example a wax coating, clay coating, polymer coating, Aluminium foil or the like, so as to prevent the absorption of liquids and other particles from the food items disposed within container 150. However, the above-enumerated materials should not be construed as limiting and it should be understood that incremental tool 100 may be formed from any material that enables container 150 to function as described herein.

It should also be appreciated that while container 150 as illustrated in the Figures has a hexagonal cross-section, the cross-section of container 150 may be any desired shape. One skilled in the art will recognize that the cross-section of container 150 may be provided as desired by altering the number of segments of hinge lines 114 as well as the number of crease lines 118, with each segment of hinge line 114 extending between a pair of crease lines 118, and each crease line 118 defining a vertex of the shape of the cross-section of container 150.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A collapsible container, comprising:
a top section;
a bottom section hingedly coupled to the top section along a first side edge of the bottom section;
a flap section disposed over the top section and hingedly coupled to the bottom section along a second side edge of the bottom section;
a pair of first endwalls, each first endwall hingedly coupled to an edge of the top section;
a pair of second endwalls, each second endwall hingedly coupled to an edge of the bottom section;
the endwalls having a substantially planar central segment that includes an edge coupled to the top or bottom section; and
at least one crease line disposed in the top section, running from proximate one of the first endwalls to proximate the other of the first endwalls, and at least one crease line disposed in the bottom section, running from proximate one of the second endwalls to proximate the other second endwall.

2. The container of claim 1, wherein each of the first endwalls is hingedly or fixedly coupled to one of the second endwalls.

3. The container of claim 1, wherein the top section comprises at least two crease lines, forming at least three subsections, including a substantially flat middle subsection and at least two angled subsections;
the bottom section comprises at least two crease lines, forming at least three subsections, including a substantially flat middle subsection and at least two angled subsections;
the endwalls comprising at least two crease lines, forming at least three endwall subsections, including a substantially planar middle section and at least two angled side sections; and
wherein the crease lines of the endwalls align with corresponding crease lines in the top or bottom section, so that when deployed, a cross section of the container may be at least substantially hexagonal, octagonal, or decagonal.

4. The container of claim 3, wherein the flap section comprises at least two crease lines, forming at least three subsections, including a substantially flat middle section and at least two angled subsections, corresponding to the subsections of the top section when flap section and top section are overlapped.

5. The container of claim 1, wherein a height of each first endwall is greater than a height of the container from the bottom section to the top section when container is not collapsed.

6. The container of claim 1, further comprising at least one aperture in the top section, bottom section, flap section, endwall, or any combination thereof.

7. The container of claim 6, wherein the at least one aperture may form at least one rim, which may be straight, notched, or scalloped, extending from the aperture to a nearest crease or hinge line.

8. The container of claim 6, further comprising a removable lid portion for sealing said at least one aperture.

9. The collapsible container of claim 1, further comprising a coupling mechanism, such as an adhesive strip, for coupling the second side edge of top section, to the flap section or bottom section proximate a hinge line coupling bottom section and flap section.

10. The collapsible container of claim 9, wherein the coupling mechanism includes an adhesive strip

11. The collapsible container of claim 1, further comprising a coupling mechanism for coupling a terminal end of the flap section to the top section and or bottom section, proximate the first side edge of the bottom section.

12. The collapsible container of claim 11, wherein the coupling mechanism includes at least one of a tab and slot, latch, adhesive, snap, bendable wire, or hook, used in combination or alone.

13. The collapsible container of claim 1, further comprising a coupling mechanism for coupling substantially flat middle portion of the flap to the substantially flat middle portion of the top section via a handle hingedly coupled to the aperture.

14. The collapsible container of claim 1 wherein the second endwalls have a sealing portion extending from and hingedly coupled to a terminal edge of the second endwalls.

15. A blank for a collapsible container, comprising:
a sheet of material divided by at least two hinge lines into a top-forming section, a bottom-forming section and a flap-forming section, where the bottom-forming section is disposed between the top-forming section and the flap-forming section;
a pair of first endwall-forming sections hingedly coupled to the top-forming section;
a pair of second endwall-forming sections hingedly coupled to the bottom-forming section; and
crease lines further dividing the top-forming section, bottom-forming section, flap-forming section, and endwall-forming sections into subsections.

16. The blank of claim 15, further comprising either at least one aperture, at least one coupling mechanism, or both at least one aperture and at least one coupling mechanism.

17. A method of forming a collapsible container, comprising:
providing blank for a collapsible container comprising a sheet of material divided by at least two hinge lines into a top-forming section, a bottom-forming section and a flap-forming section, where the bottom-forming section is disposed between the top-forming section and the flap-forming section, a pair of first endwall-forming sections hingedly coupled to the top-forming section, a pair of second endwall-forming sections hingedly coupled to the bottom-forming section, and crease lines further dividing the top-forming section, bottom-forming section, flap-forming section, and endwall-forming sections into subsections;
folding the blank so as to place the top-forming section facing and adjacent the bottom-forming section;
folding the blank so as to place the flap-forming section facing and adjacent the top-forming section; and
aligning the endwall-forming sections.

18. The method of claim 17, further comprising pivoting the first endwall-forming sections toward the bottom-forming section and the second endwall-forming sections toward the top-forming section allowing the surfaces of the first and second endwall-forming sections to overlay so as to place the collapsible container into a deployed configuration.

19. The method of claim 18, further comprising pivoting the first endwall-forming sections outward from the deployed configuration and pivoting the second endwall-forming sections outward from the deployed configuration so as to place the collapsible container into a collapsed configuration.
